(19) United States
(12) Patent Application Publication
(10) Pub. No.: US 2024/0092678 A1
(43) Pub. Date: Mar. 21, 2024

(54) CRYSTALLIZED GLASS MANUFACTURING METHOD

(71) Applicant: AGC Inc., Tokyo (JP)

(72) Inventors: Qing LI, Chiyoda-ku (JP); Seiki OHARA, Chiyoda-ku (JP)

(73) Assignee: AGC Inc., Tokyo (JP)

(21) Appl. No.: 18/520,792

(22) Filed: Nov. 28, 2023

Related U.S. Application Data
(63) Continuation of application No. PCT/JP2022/021446, filed on May 25, 2022.

(30) Foreign Application Priority Data
May 31, 2021 (JP) 2021-091740

(51) Int. Cl. C03B 32/02; C03B 11/12

(52) U.S. Cl. CPC C03B 32/02; C03B 11/125

(57) ABSTRACT

The present invention relates to a method for producing crystallized glass, including: (a1) melting a glass raw material to obtain molten glass; (a2) molding the molten glass into a predetermined shape by a molding unit to obtain a glass molded body; (a3) slowly cooling the glass molded body to obtain a raw glass plate containing at least one of a crystal nucleus and a separated phase; and (a4) heat-treating the raw glass plate containing the at least one of the crystal nucleus and the separated phase to cause crystal growth so as to obtain the crystallized glass.

### CROSS-REFERENCE TO RELATED APPLICATIONS

This is a continuation of International Application No. PCT/JP22/021446 filed on May 25, 2022, and claims priority from Japanese Patent Application No. 2021-091740 filed on May 31, 2021, the entire content of which is incorporated herein by reference.

### TECHNICAL FIELD

The present invention relates to a production method of a crystallized glass.

### BACKGROUND ART

As a glass sheet used for a cover glass or the like of a mobile terminal, high-strength glass is required, and crystallized glass is attracting attention. The crystallized glass is glass containing crystals precipitated in the glass, and is superior in strength to amorphous glass containing no crystals.

As a production method of the crystallized glass, Patent Literature 1 discloses a production method of a glass ceramic product by converting a glass article into a ceramic. The method described in Patent Literature 1 is a production method of a glass ceramic product including heating a glass product to a nucleation temperature, forming nuclei by maintaining the nucleation temperature for a predetermined time, heating the glass article to a crystallization temperature, and developing a crystal phase by maintaining the crystallization temperature for a predetermined time.

### CITATION LIST

### Patent Literature

Patent Literature 1: US2020/0017395 A1

### SUMMARY OF INVENTION

### Technical Problem

In a method in the related art described in Patent Literature 1 or the like, as shown in FIG. 1B, molten glass obtained by melting a glass raw material is molded and annealed to temporarily obtain the glass product such as a glass sheet or a glass block. Thereafter, the glass product is heated and held at a constant temperature to allow nucleation and crystal growth, thereby producing the crystallized glass. Therefore, as shown in FIG. 1B, a crystallization process involves two steps, that is, a first heat treatment (nucleation) and a second heat treatment (crystal growth), and improvements are required in terms of reducing the number of process and a time required for the process.

Therefore, an object of the present invention is to provide a production method of a crystallized glass in which a crystallization process is simplified as compared with a method in the related art.

### Solution to Problem

As a result of studying the above problems, the present inventors have found that the crystallization process can be simplified by the production method including obtaining the molten glass by melting the glass raw material, obtaining a glass molded body by molding the molten glass into a predetermined shape with a molding unit, obtaining a raw glass sheet including at least one of a crystal nucleus and a separated phase by annealing the glass molded body, and obtaining the crystallized glass by causing the crystal growth through heat treatment of the raw glass sheet, thereby completing the present invention.

The present invention relates to a production method of a crystallized glass that includes the following (a1) to (a4):
(a1) obtaining a molten glass by melting a glass raw material;
(a2) obtaining a glass molded body by molding the molten glass into a predetermined shape with a molding unit;
(a3) obtaining a raw glass sheet including at least one of a crystal nucleus and a separated phase by annealing the glass molded body; and
(a4) obtaining the crystallized glass by causing crystal growth through heat treatment of the raw glass sheet including at least one of the crystal nucleus and the separated phase.

In the production method according to the present invention, it is preferable that the (a2) and the (a3) are simultaneously performed, and the raw glass sheet including at least one of the crystal nucleus and the separated phase is obtained by annealing while molding the molten glass into the predetermined shape with the molding unit.

In the production method according to the present invention, it is preferable that the raw glass sheet including at least one of the crystal nucleus and the separated phase has a peak in small angle X-ray scattering analysis.

In the production method according to the present invention, it is preferable that the raw glass sheet including at least one of the crystal nucleus and the separated phase has an inter-particle distance of 10 nm to 100 nm as measured by small angle X-ray scattering.

The production method according to the present invention, the method further including: obtaining the molten glass by melting the glass raw material at a temperature T1 in the (a1); obtaining the raw glass sheet including at least one of the crystal nucleus and the separated phase at a temperature T2 in the (a2) and the (a3); and obtaining the crystallized glass by causing crystal growth through heat treatment of the raw glass sheet at a temperature T3 in the (a4), in which the temperature T2 is lower than the temperatures T1 and T3.

The present invention relates to a production method of a crystallized glass that includes the following (b1) to (b3):
(b1) obtaining a molten glass by melting a glass raw material;
(b2) obtaining a raw glass sheet including at least one of a crystal nucleus and a separated phase by annealing while molding the molten glass into a predetermined shape with a molding unit; and
(b3) obtaining the crystallized glass by causing crystal growth through heat treatment of the raw glass sheet including at least one of the crystal nucleus and the separated phase.

The present invention relates to a production method of a crystallized glass that includes the following (c1) to (c3):
(c1) obtaining a molten glass by melting a glass raw material;
(c2) obtaining a raw glass sheet having a peak in small angle X-ray scattering analysis by annealing while molding the molten glass into a predetermined shape with a molding unit; and
(c3) obtaining the crystallized glass by causing crystal growth through heat treatment of the raw glass sheet having the peak in the small angle X-ray scattering analysis.

The present invention relates to a production method of a crystallized glass that includes the following (d1) to (d3):
(d1) obtaining a molten glass by melting a glass raw material;
(d2) obtaining a raw glass sheet having an inter-particle distance of 10 nm to 100 nm as measured by small angle X-ray scattering by annealing w % bile molding the molten glass into a predetermined shape with a molding unit; and
(d3) obtaining the crystallized glass by causing crystal growth through heat treatment of the raw glass sheet having the inter-particle distance of 10 nm to 100 nm as measured by the small angle X-ray scattering.

The present invention relates to a production method of a crystallized glass through temperature processes of temperatures T1, T2, and 13, in which the temperature T2 is lower than the temperatures T1 and T3, and the method includes obtaining a raw glass sheet including at least one of a crystal nucleus and a separated phase at the temperature of T2.

In the production method according to the present invention,
it is preferable that the crystallized glass includes, in terms of mol % based on oxides,
40% to 70% of SiO₂,
10% to 35% of Li₂O,
1% to 15% of Al₂O₃,
0.5% to 5% of P₂O₅,
0.5% to 5% of ZrO₂.
0% to 10% of B₂O₃,
0% to 3% of Na₂O,
0% to 1% of K₂O, and
0% to 4% of SnO₂, and
the crystallized glass has a total amount of SiO₂, Al₂O₃, P₂O₅, and B₂O₃ of 60% to 80%, and
it is more preferable that the crystallized glass includes 5% or more of Al₂O₃ and 2% or more of ZrO₂.

In the production method according to the present invention, the crystallized glass preferably includes, in terms of mol % based on oxides,
50% to 70% of SiO₂,
15% to 30% of LiO,
1% to 10% of Al₂O₃,
0.5% to 5% of P₂O₅,
0.5% to 8% of ZrO₂,
0.1% to 10% of MgO,
0% to 5% of Y₂O₃,
0% to 10% of B₂O₃,
0% to 3% of Na₂O,
0% to 1% of K₂O, and
0% to 2% of SnO₂.

In the production method according to the present invention, the crystallized glass preferably has a [crystallization starting temperature (Tx)−glass transition temperature (Tg)] of 50° C. to 200° C.

### Advantageous Effects of Invention

According to the production method of a crystallized glass according to the present invention, a crystallization process can be simplified by obtaining a raw glass plate containing at least one of a crystal nucleus and a separated phase in a stage before a raw glass sheet is heat-treated to cause crystal growth, and reduction in the number of steps, reduction in process time, and simplification of equipment can be achieved.

### BRIEF DESCRIPTION OF DRAWINGS

FIG. 1A and FIG. 1B show diagrams illustrating flows, FIG. 1A shows a flow according to an aspect of a first embodiment of the present invention, and FIG. 1B shows a flow of an example of a method in the related art.

FIG. 2 is a diagram showing a flow according to an aspect of a second embodiment of the present invention.

FIG. 3 is a diagram showing a flow according to an aspect of a third embodiment of the present invention.

FIG. 4 is a diagram showing a flow according to an aspect of a fourth embodiment of the present invention.

FIG. 5 is a diagram showing a flow according to an aspect of a fifth embodiment of the present invention.

FIG. 6 is a graph showing a measurement result of small angle X-ray scattering.

FIG. 7 is a graph showing a DSC curve of a glass before causing crystal growth that is obtained according to an embodiment of the present invention.

### DESCRIPTION OF EMBODIMENTS

In the present specification, the “crystallized glass” refers to a glass in which a diffraction peak showing a crystal is observed by powder X-ray diffraction. In the powder X-ray diffraction, for example, 20 is measured in a range of 100 to 800 using a CuKα ray, and when a diffraction peak appears, the precipitated crystal is identified by, for example, a three strong ray method.

In the present specification, a term “glass phase separation” refers to separation of a single-phase glass into two or more glass phases. Whether the glass is phase-separated can be judged by scanning electron microscope (SEM). In the case where the glass is phase-separated, it can be observed by SEM that the glass is separated into two or more phases.

Examples of a state of the phase-separated glass include a binodal state and a spinodal state. The binodal state is a phase separated by a nucleation and growth mechanism, and is generally spherical. Further, the spinodal state is a state in which the separated phases are three-dimensionally and continuously entangled with each other with some degree of regularity.

In the present specification, “having a peak in small angle X-ray scattering” means a case in which [highest intensity]/[intensity when Q(nm⁻¹) is 3], which is a value obtained by dividing the highest intensity by the intensity when Q(nm⁻¹) is 3, is greater than 1. Specific examples of measurement conditions for the small angle X-ray scattering (SAXS) are shown below.
Energy (wavelength): 0.92 Å
Measurement detector: PILATUS
Measurement time: 480 sec
Measurement camera length: 2180.9 mm

In the present specification, the “amorphous glass” refers to a glass that contains no crystal phase and a glass in which a diffraction peak indicating the crystal is not observed by the powder X-ray diffraction.

In the present specification, the “amorphous glass” and the “crystallized glass” may be collectively referred to simply as “glass”.

In the present specification, a glass composition is expressed in terms of mol % based on oxides unless otherwise specified. Further, in the present specification, in the case where the glass composition is simply expressed as “%”, “%” means mol %, Furthermore, regarding the glass composition, “substantially not contained” means that a component has a content less than an impurity level contained in the raw materials and the like, that is, the component is not intentionally added. Specifically, the content is less than 0.1%, for example. Moreover, in the present specification, “mass %” is synonymous with “weight %”. In the present specification, “to” representing a numerical range includes upper and lower limits.

Hereinafter, a production method of a crystallized glass according to the present invention will be described in detail with reference to a flowchart.

### First Embodiment

A first embodiment according to the present invention includes the following steps (a1) to (a4):
(a1) a step of obtaining a molten glass by melting a glass raw material;
(a2) a step of obtaining a glass molded body by molding the molten glass into a predetermined shape with a molding unit;
(a3) a step of obtaining a raw glass sheet including at least one of a crystal nucleus and a separated phases by annealing the glass molded body; and
(a4) a step of obtaining the crystallized glass by causing crystal growth through heat treatment of the raw glass sheet including at least one of the crystal nucleus and the separated phase.

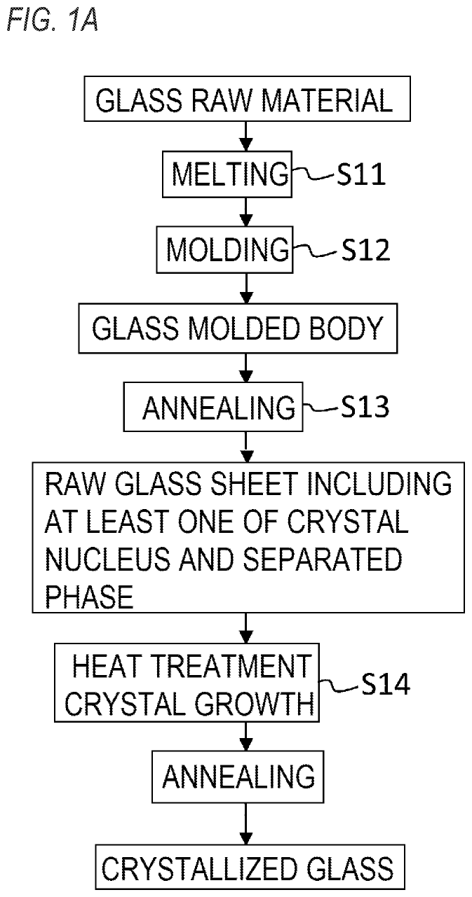

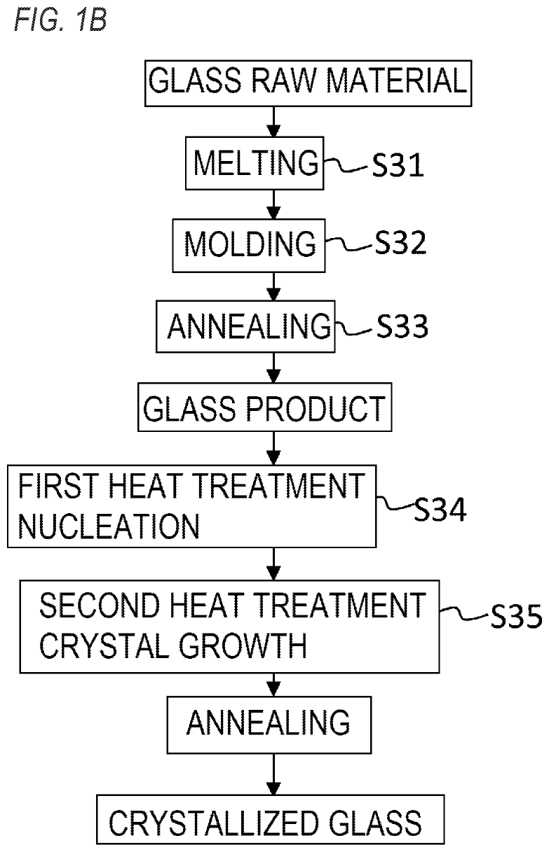

FIG. 1A is a flowchart showing an aspect of the first embodiment. In the aspect of the first embodiment, the molten glass is obtained by melting the glass raw material in step S11. In step S12, the molten glass is molded into the predetermined shape with the molding unit, thereby obtaining the glass molded body. In step S13, the glass molded body is annealed, thereby obtaining the raw glass sheet including at least one of the crystal nucleus and the separated phase. In step S14, the raw glass sheet is heat-treated to cause crystal growth, followed by annealed, thereby obtaining the crystallized glass.

FIG. 1B is a flowchart showing an example of a production method in the related art. In the production method in the related art, the glass raw material is melted to obtain the molten glass in step S31. In step 32, the molten glass is molded into the predetermined shape with the molding unit, and in step 33, the molten glass is annealed to obtain a glass product. The glass product is subjected to a first heat treatment to form a nucleus in step S34 and a second heat treatment to cause the crystal growth in step S35, followed by annealed, thereby obtaining a crystallized glass.

Each step of the first embodiment of the present invention will be described below.

(a1) Step of Obtaining a Molten Glass by Melting a Glass Raw Material

The step (a1) is a step of obtaining the molten glass by preparing and melting the glass raw material. A known melting method can be used for melting the glass. Specifically, for example, the glass raw material is continuously fed into a melting furnace and melted in a high temperature region to thereby obtain the molten glass. A preferred glass composition in the present invention will be described later.

The temperature at which the glass raw material is melted can be appropriately set according to the composition or the like of the glass raw material, and is typically preferably 1200° C. or higher, more preferably 1300° C. or higher, still more preferably 1400° C. or higher, particularly preferably 1450° C. or higher, and most preferably 1500° C. or higher in order to obtain homogeneous glass. Further, in consideration of erosion and damage of melting equipment, the temperature at which the glass raw material is melted is preferably 1700° C. or less, more preferably 1600° C. or less, still more preferably 1550° C. or less, and particularly preferably 1500° C. or less.

When the temperature at which the glass raw material is melted in the step (a1) is set as T1, and a temperature at which the raw glass sheet including at least one of the crystal nucleus and the separated phase is obtained is set as T2 in the step (a3) to be described later, or in the steps (a2) and (a3) in the case where the steps (a2) and (a3) are performed simultaneously, T1 is preferably higher than T2.

Specifically, in a temperature range from a temperature at which the molten glass is obtained to the temperature at which the raw glass sheet including at least one of the crystal nucleus and the separated phase is obtained, the temperature range is preferably below T1. The temperature (T1−T2) (° C.) is preferably 500° C. or more, more preferably 600° C. or more, and still more preferably 700° C. or more in order to stably form at least one of the crystal nucleus and the separated phase. Further, in the case where the temperature (T1−T2) (° C.) is too large, it is difficult to break the glass during molding or to produce at least one of the crystal nucleus and the separated phase, and thus the temperature (T1−T2) (° C.) is preferably 1000° C. or lower, more preferably 900° C. or lower, and still more preferably 800° C. or lower.

(a2) Step of Obtaining a Glass Molded Body by Molding the Molten Glass into a Predetermined Shape with a Molding Unit

The step (a2) is a step of supplying the molten glass obtained in the step (a1) to the molding unit and molding the molten glass into the predetermined shape to thereby obtain the glass molded body. The molding unit is not particularly limited, and examples thereof include a mold. A material of the mold is not limited, and examples thereof include various heat-resistant alloys (for example, stainless steel), a superhard material including tungsten carbide as a main component, various ceramics (for example, silicon carbide and silicon nitride), and a composite material including carbon.

Specific examples of an aspect of the step (a2) include an aspect in which the molten glass is poured into the mold and glass molded body is continuously pulled out from the mold to thereby obtain the glass molded body.

A shape of the glass molded body is not particularly limited, and examples thereof include a rectangular parallelepiped shape. A cross-sectional shape of the glass molded body is not particularly limited, and examples thereof include a rectangle, a square, an ellipse, and a circle. A thickness of the glass molded body can be adjusted by an amount of the molten glass supplied to the molding unit and a height of the molding unit. In addition, a width of the molding unit may be a width of the glass molded body.

The thickness of the glass molded body is preferably 0.5 mm or more, more preferably 0.7 mm or more, and still more preferably 0.9 mm or more. In addition, the thickness of the glass molded body is preferably 50 mm or less, more preferably 45 mm or less, still more preferably 40 mm or less, and particularly preferably 35 mm or less. In the case where the thickness of the glass molded body falls within the above range, at least one of the crystal nucleus and the separated phase is easily formed in the raw glass sheet obtained by annealing the glass molded body. In the case where a plurality of crystallized glass products is desired to be obtained by slicing a glass block in a subsequent step, a thickness of glass is preferably 5 mm or more, more preferably 10 mm or more, still more preferably 15 mm or more, and particularly preferably 20 mm or more.

The width of the glass molded body is preferably 100 mm or more, more preferably 150 mm or more, still more preferably 200 mm or more, particularly preferably 3M) mm or more, and most preferably 400 mm or more. In the case where the width of the glass molded body is within the above range, the crystallized glass can be cut in the subsequent step, and a large number of crystallized glass products can be obtained at the same time. An upper limit of the width of the glass molded body is not particularly limited, and is preferably 5000 mm or less, more preferably 3000 mm or less, still more preferably 1000 mm or less, and particularly preferably 500 mm or less from the viewpoint of handling.

(a3) Step of Obtaining a Raw Glass Sheet Including at Least One of a Crystal Nucleus and a Separated Phases by Annealing the Glass Molded Body

The step (a3) is a step of cooling the glass molded body obtained in the step (a2) gradually from a melting temperature to generate the crystal nucleus and/or phase-separate in the glass molded body, thereby obtaining the raw glass sheet including at least one of the crystal nucleus and the separated phase.

The raw glass sheet includes at least one of the crystal nucleus and the separated phase, and preferably includes at least the crystal nucleus. Specific examples of the raw glass sheet include a raw glass sheet including only one of the crystal nucleus and the separated phase, and a raw glass sheet including both the crystal nucleus and the separated phase, and the raw glass sheet including only the crystal nucleus is preferred.

Whether the crystal nucleus is generated in the raw glass sheet and/or the glass molded body is phase-separated can be checked by subjecting the raw glass sheet to the small angle X-ray scattering. Since general glass is uniformly amorphous, internal scattering is not observed in SAXS measurement. By including at least one of the crystal nucleus and the separated phase, the glass becomes a glass including extremely minute scattering, and the scattering is observed.

The raw glass sheet including at least one of the crystal nucleus and the separated phase obtained in the step (a3) preferably has a peak in the small angle X-ray scattering analysis. Specifically, for example, regarding the peak obtained by the small angle X-ray scattering, [highest intensity]/[intensity when Q(nm⁻¹) is 3] is preferably greater than 1, more preferably 1.1 or more, still more preferably 1.2 or more, and particularly preferably 1.3 or more. By the peak being present in the small angle X-ray scattering analysis, at least one of the crystal nucleus and the separated phase in the raw glass sheet is sufficiently formed, the crystallization process can be simplified, and stable crystallized glass can be obtained.

The raw glass sheet including at least one of the crystal nucleus and the separated phase obtained in the step (a3) preferably has an inter-particle distance between particles present in the glass of 10 nm to 100 nm as determined by small angle X-ray scattering measurement.

The inter-particle distance calculated from the small angle X-ray scattering measurement represents a distance between the particles included in the glass. It is considered that the smaller the inter-particle distance is, the more a particle structure included in the glass is, so that scattering becomes stronger and transmittance tends to decrease. The inter-particle distance is preferably 10 nm or more from the viewpoint of preventing the strong scattering and improving the transmittance. The inter-particle distance is preferably 100 nm or less in order to promote the crystal growth.

The inter-particle distance is preferably 10 nm or more, more preferably 15 nm or more, and still more preferably 20 nm or more. The inter-particle distance is more preferably 80 nm or less, still more preferably 70 nm or less, particularly preferably 60 nm or less, extremely preferably 50 nm or less, most preferably 40 nm or less, and particularly preferably 30 nm or less.

The temperature at which the glass molded body is annealed in the step (a3) can be appropriately set such that at least one of the crystal nucleus and the separated phase is included in consideration of the glass composition and the thickness of the glass molded body, and the glass molded body is generally preferably annealed to a temperature equal to or lower than [glass transition temperature+300° C.], more preferably to a temperature equal to or lower than [glass transition temperature+200° C.], and still more preferably to a temperature equal to or lower than [glass transition temperature+100° C.].

In the case where the glass is handled before the step (a4), the glass is preferably annealed to 100° C. or lower. Since there is a high possibility that strain will remain in the glass molded body and the glass molded body will crack in the case where a annealing temperature is too low, generally, it is preferable to anneal to a temperature equal to or higher than [glass transition temperature−50° C.], more preferably to the glass transition temperature or higher, and still more preferably to a temperature equal to or higher than [glass transition temperature+30° C.].

A time for which the glass molded body is annealed in order to include at least one of the crystal nucleus and the separated phase in the raw glass sheet is not particularly limited, and is usually preferably 3 minutes or more, more preferably 5 minutes or more, and still more preferably 10 minutes or more. Further, the time for which the glass molded body is annealed is preferably 8 hours or less, more preferably 6 hours or less, still more preferably 5 hours or less, even more preferably 4 hours or less, particularly preferably 3 hours or less, most preferably 2 hours or less, and extremely preferably 1 hour or less.

The step (a2) and the step (a3) may be performed simultaneously, or the raw glass sheet including at least one of the crystal nucleus and the separated phase is obtained by annealing while molding the molten glass into the predetermined shape with the molding unit. Specific examples of an aspect in which the step (a2) and the step (a3) are simultaneously performed include an aspect in which the molten glass is poured into the mold, and the glass molded body is continuously pulled out from the mold, molded and annealed to thereby obtain the raw glass sheet including at least one of the crystal nucleus and the separated phase.

When the temperature at which the raw glass sheet including at least one of the crystal nucleus and the separated phase is obtained is set as T2 in the step (a3) or in the steps (a2) and (a3) in the case where the steps (a2) and (a3) are performed simultaneously, a temperature at which the glass raw material is melted in the step (a1) is set as T1, and a temperature at which the raw glass sheet is heat-treated to cause the crystal growth so as to obtain the crystallized glass in the step (a4) is set as T3, T2 is preferably lower than T1 and T3.

Specifically, in the temperature range from the temperature at which the molten glass is obtained to the temperature at which the raw glass sheet including at least one of the crystal nucleus and the separated phase is obtained, the temperature range is preferably below T1 and T3. By setting T2 lower than T1 and T3, the crystal growth can be achieved in a stable glass shape.

(a4) Step of Obtaining the Crystallized Glass by Causing Crystal Growth Through Heat Treatment of the Raw Glass Sheet Including at Least One of the Crystal Nucleus and the Separated Phase.

The step (a4) is a step of raising a temperature of the raw glass sheet including at least one of the crystal nucleus and the separated phase obtained in the step (a3) to a crystal growth temperature and holding the raw glass sheet for a predetermined time to cause the crystal growth so as to obtain the crystallized glass.

A temperature of the heat treatment in the step (a4) is preferably [crystallization starting temperature+20° C.] or higher, more preferably [crystallization starting temperature+40° C.] or higher, and still more preferably [crystallization starting temperature+60° C.] or higher, from the viewpoint of stable crystal growth. Further, in order to obtain transparent crystallized glass, the temperature is preferably [crystallization starting temperature+200° C.] or lower, more preferably [crystallization starting temperature+180° C.] or lower, and still more preferably [crystallization starting temperature+150° C.] or lower.

For example, the temperature of the heat treatment is preferably 400° C. or higher, more preferably 500° C. or higher, even more preferably 600° C. or higher, particularly preferably 650° C. or higher, and most preferably 700° C. or higher, from the viewpoint of the stable crystal growth. Further, in order to obtain the transparent crystallized glass, the temperature of the heat treatment is preferably 1000° C. or less, more preferably 900° C. or less, and still more preferably 800° C. or less.

When the temperature at which the crystallized glass is obtained by causing the crystal growth through heat treatment of the raw glass sheet in the step (a4) is set as T3, and a temperature at which the raw glass sheet including at least one of the crystal nucleus and the separated phase is obtained is set as T2 in the step (a3) or in the steps (a2) and (a3) in the case where the steps (a2) and (a3) are performed simultaneously, T3 is preferably higher than T2. Specifically, in the temperature range from the temperature at which the molten glass is obtained to the temperature at which the raw glass sheet including at least one of the crystal nucleus and the separated phase is obtained, the temperature range is preferably below T3.

The temperature (T3−T2) (° C.) is preferably 10° C. or higher, more preferably 30° C. or higher, and still more preferably 50° C. or higher, from the viewpoint that the temperature of T2 is preferably low in order to cause the crystal growth in the stable glass shape. In the case where the temperature (T3−T2) (° C.) is too large, the crystal growth will be vigorous and it is difficult to obtain transparency, and thus the temperature (T3−T2) (° C.) is preferably 350° C. or lower, more preferably 300° C. or lower, and still more preferably 250° C. or lower.

A time for the heat treatment in the step (a4) is preferably 10 minutes or more, more preferably 30 minutes or more, still more preferably 1 hour or more, particularly preferably 1.5 hours or more, and most preferably 2 hours or more from the viewpoint of the stable crystal growth. In order to obtain the transparent crystallized glass, the time is preferably 10 hours or less, more preferably 8 hours or less, still more preferably 6 hours or less, particularly preferably 4 hours or less, and most preferably 3 hours or less.

### Second Embodiment

The second embodiment according to the present invention includes the following steps (b1) to (b3):
(b1) a step of obtaining a molten glass by melting a glass raw material:
(b2) a step of obtaining a raw glass sheet including at least one of a crystal nucleus and a separated phase by annealing while molding the molten glass into a predetermined shape with a molding unit; and
(b3) a step of obtaining the crystallized glass by causing crystal growth through heat treatment of the raw glass sheet including at least one of the crystal nucleus and the separated phase.

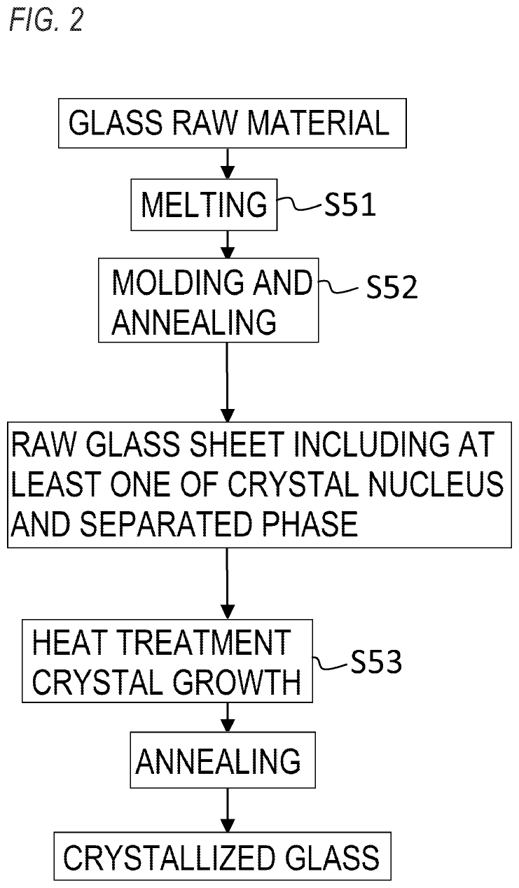

FIG. 2 is a flowchart showing an aspect according to the second embodiment. In an aspect according to the second embodiment, the molten glass is obtained by melting the glass raw material in step S51. The molten glass is annealed while being molded into a predetermined shape with the molding unit in step S52 to thereby obtain the raw glass sheet including at least one of the crystal nucleus and the separated phase. The raw glass sheet is heat-treated to cause the crystal growth in step S53, and then is annealed to obtain the crystallized glass.

Specific examples of an aspect according to the second embodiment include an aspect in which the molten glass is poured into a mold, the glass molded body is molded and annealed while being continuously pulled out from the mold to obtain the raw glass sheet including at least one of the crystal nucleus and the separated phase, and the raw glass sheet is heat-treated to cause the crystal growth so as to obtain the crystallized glass.

### Third Embodiment

The third embodiment according to the present invention includes the following steps (c1) to (c3):
(c1) a step of obtaining a molten glass by melting a glass raw material;
(c2) a step of obtaining a raw glass sheet having a peak in small angle X-ray scattering analysis by annealing while molding the molten glass into a predetermined shape with a molding unit and; and
(c3) a step of obtaining the crystallized glass by causing crystal growth through heat treatment of the raw glass sheet having the peak in the small angle X-ray scattering analysis.

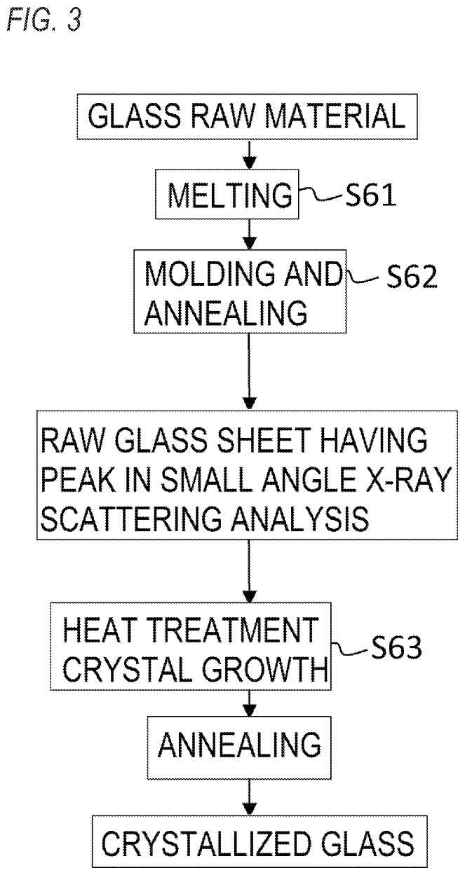

FIG. 3 is a flowchart showing an aspect of the third embodiment. In the aspect of the third embodiment, the molten glass is obtained by melting the glass raw material in step S61. The molten glass is annealed while being molded into the predetermined shape with the molding unit in step S62, and the raw glass sheet having the peak in the small angle X-ray scattering analysis is obtained. The raw glass sheet is heat-treated to cause the crystal growth in step S63, and then is annealed to thereby obtain the crystallized glass.

Specific examples of an aspect according to the third embodiment include an aspect in which the molten glass is poured into a mold, the glass molded body is molded and annealed while being continuously pulled out from the mold to obtain the raw glass sheet having the peak in the small angle X-ray scattering, and the raw glass sheet is heat-treated to cause the crystal growth so as to obtain the crystallized glass.

### Fourth Embodiment

The fourth embodiment according to the present invention includes the following steps (d1) to (d3):
(d1) a step of obtaining a molten glass by melting a glass raw material;
(d2) a step of obtaining a raw glass plate having an inter-particle distance of 10 nm to 100 nm as measured by small angle X-ray scattering by annealing while molding the molten glass into a predetermined shape with a molding unit; and
(d3) a step of obtaining the crystallized glass by causing crystal growth through heat treatment of the raw glass sheet having the inter-particle distance of 10 nm to 100 nm as measured by the small angle X-ray scattering.

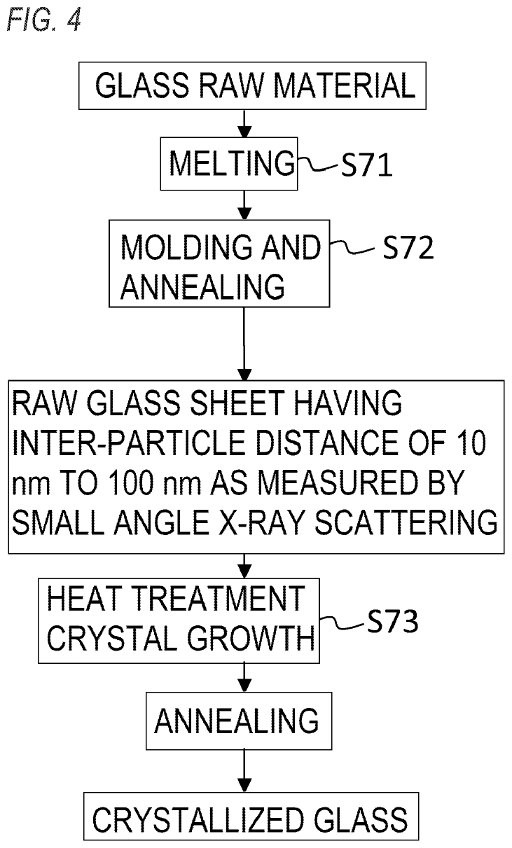

FIG. 4 is a flowchart showing an aspect according to the fourth embodiment. In the aspect according to the fourth embodiment, the molten glass is obtained by melting the glass raw material in step S71. The molten glass is annealed while being molded into the predetermined shape with the molding unit in step S72 to thereby obtain the raw glass sheet having the inter-particle distance of 10 nm to 100 nm as measured by the small angle X-ray scattering. The raw glass sheet is heat-treated to cause the crystal growth in step S73, and then is annealed to thereby obtain the crystallized glass.

Specific examples of an aspect according to the fourth embodiment include an aspect in which the molten glass is poured into a mold, the glass molded body is molded and annealed while being continuously pulled out from the mold to obtain the raw glass sheet having the inter-particle distance of 10 nm to 100 nm as measured by the small angle X-ray scattering, and the raw glass sheet is heat-treated to cause the crystal growth so as to obtain the crystallized glass.

### Fifth Embodiment

The fifth embodiment according to the present invention is a production method of a crystallized glass through temperature processes of temperatures T1, T2, and T3, in which T2 is lower than T1 and T3, and a raw glass sheet including at least one of a crystal nucleus and a separated phase at the temperature of T2 is obtained. Specifically, in the temperature range from the temperature at which the molten glass is obtained to the temperature at which the raw glass sheet including at least one of the crystal nucleus and the separated phase is obtained, the temperature range is preferably below T1 and T3.

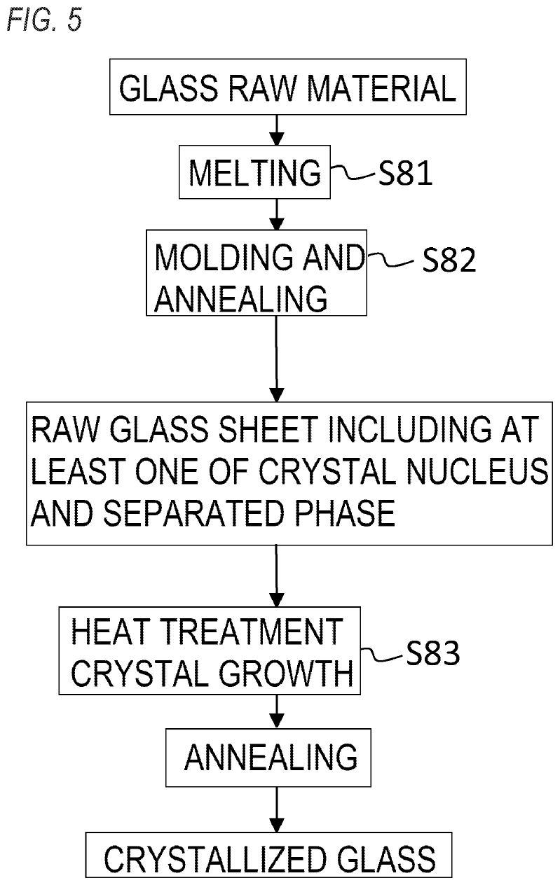

FIG. 5 is a flowchart showing an aspect according to the fifth embodiment. In an aspect according to the fifth embodiment, when a temperature at which the glass raw material is melted to obtain a molten glass in step S81 is set as T1, a temperature at which the molten glass is annealed while being molded into a predetermined shape with a molding unit in step S82 to obtain the raw glass sheet including at least one of the crystal nucleus and the separated phase is set as T2, and a temperature at which the raw glass sheet is heat-treated to cause crystal growth in step S83 is set as T3, T2 is set as a temperature lower than T1 and T3.

<Glass Compositions>

Preferable glass compositions in the production method according to the present embodiment include the following glass compositions A and B.

(Glass Composition A)

The glass composition A preferably includes, in terms of mol % based on oxides:
40% to 70% of SiO₂;
10% to 35% of Li₂O;
1% to 15% of Al₂O₃;
0.5% to 5% of P₂O₅;
0.5% to 5% of ZrO₂;
0% to 10% of B₂O₃;
0% to 3% of Na₂O;
0% to 1% of K₂O; and
0% to 4% of SnO₂.

(Glass Composition B)

The glass composition B preferably includes, in terms of mol % based on oxides:
50% to 70% of SiO₂;
15% to 30% of Li₂O;
1% to 10% of Al₂O₃;
0.5% to 5% of P₂O₅;
0.5% to 8% of ZrO₂;
0.1% to 10% of MgO;
0% to 5% of Y₂O₃;
0% to 10% of B₂O₃;
0% to 3% of Na₂O;
0% to 1% of K₂O; and
0% to 2% of SnO₂.

Further, a total amount of SiO₂, Al₂O₃, P₂O₅, and B₂O₃ is preferably 60% to 80% in terms of mol % based on oxides. SiO₂, Al₂O₃, P₂O₅, and B₂O₃ are glass network formers (hereinafter abbreviated as NWF). In the case where the total amount of NWF is large, strength of the glass is increased. Therefore, the total amount of NWF is preferably 60% or more, more preferably 63% or more, and particularly preferably 65% or more, in order to increase a fracture toughness value of the crystallized glass. However, glass including too many NWF has a high melting temperature and is difficult to produce, so the total amount of NWF is preferably 80% or less, more preferably 75% or less, and still more preferably 70% or less.

A ratio of a total amount of Li₂O, Na₂O, and K₂O to the total amount of NWF, that is, the total amount of SiO₂, Al₂O₃, P₂O₅, and B₂O₃ is preferably 0.20 to 0.60.

Li₂O, Na₂O and K₂O are network modifiers, and lowering the ratio of network modifiers to NWF increases a void in a network and thus improves impact resistance. Therefore, a ratio of the total amount of Li₂O, Na₂O, and K₂O to the total amount of NWF, that is, SiO₂, Al₂O₃, P₂O₅, and B₂O₃ is preferably 0.60 or less, more preferably 0.55 or less, and particularly preferably 0.50 or less. On the other hand, Li₂O, Na₂O, and K₂O are components necessary for chemical strengthening, and in the case where the crystallized glass is chemically strengthened, the ratio of the total amount of Li₂O, Na₂O, and K₂O to the total amount of NWF, that is, SiO₂, Al₂O₃, P₂O₅, and B₂O₃ is preferably 0.20 or more, more preferably 0.25 or more, and particularly preferably 0.30 or more in order to improve a chemical strengthening characteristic.

SiO₂ is a component forming a glass network structure. Further, SiO₂ is a component that increases chemical durability, a content of SiO₂ is preferably 40% or more, more preferably 45% or more, still more preferably 48% or more, even more preferably 50% or more, particularly preferably 52% or more, and extremely preferably 54% or more. On the other hand, in order to improve meltability, the content of SiO₂ is preferably 70% or less, more preferably 68% or less, still more preferably 66% or less, and particularly preferably 64% or less.

Al₂O₃ is a component that increases a surface compressive stress due to the chemical strengthening. A content of Al₂O₃ is preferably 1% or more, more preferably 2% or more, still more preferably 3% or more, and is, in the following preferable order, 5% or more, 5.5% or more, 6% or more, 6.5% or more, or 7% or more. On the other hand, the content of Al₂O₃ is preferably 15% or less, more preferably 12% or less, still more preferably 10% or less, particularly preferably 9% or less, and most preferably 8% or less in order to prevent the glass from having an excessively high devitrification temperature.

Li₂O is a component that forms the surface compressive stress by ion exchange, and is a constituent component of a primary crystal. A content of LiO is preferably 10% or more, more preferably 14% or more, still more preferably 15% or more, particularly preferably 18% or more, extremely preferably 20% or more, and most preferably 22% or more. On the other hand, in order to stabilize the glass, the content of Li₂O is preferably 35% or less, more preferably 32% or less, still more preferably 30% or less, particularly preferably 28% or less, and most preferably 26% or less.

Na₂O is a component that improves the meltability of the glass. In the case where Na₂O is included, a content thereof is preferably 0.5% or more, more preferably 1% or more, and particularly preferably 2% or more. In the case where the content of Na₂O is too high, the crystal is difficult to precipitate, or in the case where the crystallized glass is chemically strengthened, the chemical strengthening characteristic is lowered, and therefore, the content of Na₂O is preferably 3% or less, more preferably 2.8% or less, and still more preferably 2.5% or less.

K₂O, like Na₂O, is a component that lowers the melting temperature of the glass and may be included. In the case where K₂O is included, a content thereof is preferably 0.1% or more, and more preferably 0.5% or more. In the case of chemically strengthening the crystallized glass, in the case where the content of K₂O is too high, the chemical strengthening characteristic is reduced, or the chemical durability is reduced, and therefore, the content K₂O is preferably 1% or less, more preferably 0.8% or less, and still more preferably 0.6% or less.

A total content Na₂O+K₂O of Na₂O and K₂O is preferably 1% or more, and more preferably 1.5% or more in order to improve the meltability of the glass raw material.

In the case of chemically strengthening the crystallized glass, in the case where a ratio K₂O/R₂O of the K₂O content to the total content of Li₂O, Na₂O, and K₂O (hereinafter also abbreviated as R₂O) is 0.2 or less, the chemical strengthening characteristic and chemical durability can be enhanced, which is preferable. K₂O/R₂O is more preferably 0.15 or less, and still more preferably 0.10 or less.

R₂O is preferably 10% or more, more preferably 15% or more, and still more preferably 20% or more. Further, R₂O is preferably 29% or less, and more preferably 26% or less.

In order to promote crystallization, a content of P₂O₅ is preferably 0.5% or more, more preferably 1% or more, still more preferably 1.5% or more, particularly preferably 2% or more, and extremely preferably 2.5% or more. On the other hand, in the case where the content of P₂O₅ is too high, phase separation tends to occur during melting and acid resistance is remarkably lowered, and therefore, the content of P₂O₅ is preferably 5% or less, more preferably 4.8% or less, still more preferably 4.5% or less, and particularly preferably 4.2% or less. P₂O₅ is a constituent component of a Li₃PO₄ crystal in the case where the crystallized glass includes the Li₃PO₄ crystal.

ZrO₂ is a component that enhances mechanical strength and chemical durability, and is preferably included in order to remarkably improve CS. A content of ZrO₂ is preferably 0.5% or more, more preferably 1% or more, still more preferably 1.5% or more, particularly preferably 2% or more, and most preferably 2.5% or more. On the other hand, in order to prevent devitrification during the melting, the content of ZrO₂ is preferably 8% or less, more preferably 7.5% or less, still more preferably 7% or less, and particularly preferably 6% or less. In the case where the content of ZrO₂ is too high, the devitrification temperature rises and then viscosity decreases. Since deterioration of moldability is prevented due to such a decrease in viscosity, in the case where a molding viscosity is low, the content of ZrO₂ is preferably 5% or less, more preferably 4.5% or less, and still more preferably 3.5% or less.

ZrO₂/R₂O is preferably 0.02 or more, more preferably 0.03 or more, further preferably 0.04 or more, particularly preferably 0.1 or more, and most preferably 0.15 or more, in order to increase the chemical durability. ZrO₂/R₂O is preferably 0.6 or less, more preferably 0.5 or less, still more preferably 0.4 or less, and particularly preferably 0.3 or less, in order to increase the transparency after crystallization.

MgO is a component that stabilizes the glass, and is also a component that enhances the mechanical strength and chemical resistance, and therefore. MgO is preferably included in the case where the content of Al₂O₃ is relatively low. A content of MgO is preferably 0.1%, more preferably 1% or more, still more preferably 2% or more, even more preferably 3% or more, and particularly preferably 4% or more. On the other hand, in the case where too much MgO is added, the viscosity of the glass is lowered, and the devitrification or the phase separation tends to occur, and therefore, the content of MgO is preferably 10% or less, more preferably 9% or less, even more preferably 8% or less, and particularly preferably 7% or less.

TiO₂ is a component capable of promoting the crystallization and may be included. In the case where TiO₂ is included, a content thereof is preferably 0.2% or more, and more preferably 0.5% or more. On the other hand, the content of TiO₂ is preferably 4% or less, more preferably 2% or less, and still more preferably 1% or less, in order to prevent the devitrification during the melting.

SnO₂ has an effect of promoting formation of the crystal nucleus and may be included. In the case where SnO₂ is included, a content thereof is preferably 0.5% or more, more preferably 1% or more, still more preferably 1.5% or more, and particularly preferably 2% or more. On the other hand, the content of SnO₂ is preferably 4% or less, more preferably 3% or less, and still more preferably 2% or less, in order to prevent the devitrification during the melting.

Y₂O₃ is a component having an effect of making it difficult for fragments to scatter when chemically strengthened glass is broken in the case where the crystallized glass is chemically strengthened, and Y₂O₃ may be included. A content of Y₂O₃ is preferably 1% or more, more preferably 1.5% or more, still more preferably 2% or more, particularly preferably 2.5% or more, and extremely preferably 3% or more. On the other hand, in order to prevent the devitrification during the melting, the content of Y₂O₃ is preferably 5% or less, and more preferably 4% or less.

B₂O₃ is a component that improves chipping resistance of the glass and improves the meltability, and may be included. In the case where B₂O₃ is included, a content thereof is preferably 0.5% or more, more preferably 1% or more, and still more preferably 2% or more, in order to improve the meltability. On the other hand, in the case where the content of B₂O₃ is too high, a quality of the crystallized glass is likely to deteriorate, such as striae occurring during the melting, so the content of B₂O₃ is preferably 10% or less. The content of B₂O₃ is more preferably 8% or less, still more preferably 6% or less, and particularly preferably 4% or less.

All of BaO, SrO, MgO, CaO, and ZnO are components that improve the meltability of the glass and may be included. In the case where these components are included, a total content of BaO, SrO, MgO, CaO, and ZnO (hereinafter also abbreviated as BaO+SrO+MgO+CaO+ZnO) is preferably 0.5% or more, more preferably 1% or more, still more preferably 1.5% or more, and particularly preferably 2% or more. On the other hand, BaO+SrO+MgO+CaO+ZnO is preferably 8% or less, more preferably 6% or less, still more preferably 5% or less, and particularly preferably 4% or less, since an ion exchange rate decreases.

Among these, BaO, SrO, and ZnO may be included in order to improve light transmittance of the crystallized glass by improving a refractive index of residual glass and bringing the residual glass closer to a precipitated crystal phase, thereby lowering a haze value. In this case, the total content of BaO, SrO, and ZnO (hereinafter also abbreviated as BaO+SrO+ZnO) is preferably 0.3% or more, more preferably 0.5% or more, still more preferably 0.7% or more, and particularly preferably 1% or more. On the other hand, these components may reduce the ion exchange rate. In the case where the crystallized glass is chemically strengthened, in order to improve the chemical strengthening characteristic, the content of BaO+SrO+ZnO is preferably 2.5% or less, more preferably 2% or less, still more preferably 1.7% or less, and particularly preferably 1.5% or less.

La₂O₃, Nb₂O₅, and Ta₂O₅ are all components that make it difficult for fragments to scatter when the chemically strengthened glass is broken in the case where the crystallized glass is chemically strengthened, and La₂O₃, Nb₂O₅, and Ta₂O₅ may be included in order to increase the refractive index. In the case where these components are included, a total content of La₂O₃, Nb₂O₅ and Ta₂O₅ (hereinafter also abbreviated as La₂O₃+Nb₂O+Ta₂O₅) is preferably 0.5% or more, more preferably 1% or more, still more preferably 1.5% or more, and particularly preferably 2% or more. Further, La₂O₃+Nb₂O₅+Ta₂O₅ is preferably 4% or less, more preferably 3% or less, still more preferably 2% or less, and particularly preferably 1% or less since the glass is less likely to devitrify during the melting.

The glass according to the present embodiment may include CeO₂. CeO₂ may prevent coloring caused by oxidizing the glass. In the case where CeO₂ is included, a content thereof is preferably 0.03% or more, more preferably 0.05% or more, and still more preferably 0.07% or more. The content of CeO₂ is preferably 1.5% or less, and more preferably 1.0% or less, in order to increase the transparency.

In the case where the crystallized glass is used in a colored state, a coloring component may be added within a range that does not inhibit achievement of a desired characteristic. Examples of the coloring component include Co₃O₄, MnO₂, Fe₂O₃, NiO, CuO, Cr₂O₃, V₂O₅, Bi₂O₃, SeO₂, Er₂O₃ and Nd₂O₃.

A content of the coloring component is preferably in a range of 1% or less. In the case where it is desired to increase visible light transmittance of the glass, it is preferred that these components are not substantially included.

HfO₂, Nb₂O₅, and Ti₂O₃ may be added in order to increase weather resistance against irradiation with ultraviolet light. In the case where HfO₂, Nb₂O₅, and Ti₂O₃ are added for the purpose of increasing the weather resistance against the irradiation with the ultraviolet light, a total content of HfO₂, Nb₂O₅, and Ti₂O₃ is preferably 1% or less, more preferably 0.5% or less, and still more preferably 0.1% or less in order to reduce effects on other characteristics.

SO₃, a chloride, and a fluoride may be appropriately included as refining agents during the melting of the glass. A content of component that functions as the refining agent is, as represented by mass % based on oxides, preferably 2% or less, more preferably 1% or less, and still more preferably 0.5% or less, since the strengthening characteristic and crystallization behavior may be affected in the case where too many components are added. Although a lower limit thereof is not particularly limited, the content thereof is typically preferably 0.05% or more as represented by mass % based on oxides.

In the case where SO₃ is used as the refining agent, a content of SO₃ is, as represented by mass % based on oxides, preferably 0.01% or more, more preferably 0.05% or more, and still more preferably 0.1% or more, since an effect thereof cannot be achieved in the case where the content thereof is too small. In the case where SO₃ is used as the refining agent, the content of SO₃ is, as represented by mass % based on oxides, preferably 1% or less, more preferably 0.8% or less, and still more preferably 0.6% or less.

In the case where Cl is used as the refining agent, a content of Cl is, as represented by mass % based on oxides, preferably 1% or less, more preferably 0.8% or less, and still more preferably 0.6% or less, since physical properties such as the strengthening characteristic may be affected in the case where Cl is added too much. In the case where Cl is used as the refining agent, the content of Cl is, as represented by mass % based on oxides, preferably 0.05% or more. more preferably 0.1% or more, and still more preferably 0.2% or more, since the effect thereof cannot be achieved in the case where the content thereof is too small.

In the case where SnO₂ is used as the refining agent, the content of SnO₂ is, as represented by mass % based on oxides, preferably 1% or less, more preferably 0.5% or less, and still more preferably 0.3% or less, since the crystallization behavior is affected in the case where SnO₂ is added too much. In the case where SnO₂ is used as the refining agent, the content of SnO₂ is, as represented by mass % based on oxides, preferably 0.02% or more, more preferably 0.05% or more, and still more preferably 0.1% or more, since the effect thereof cannot be achieved in the case where the content thereof is too small.

As₂O₃ is preferably not included. In the case where Sb₂O₃ is included, a content thereof is preferably 0.3% or less, more preferably 0.1% or less, and most preferably not included.

<Crystallized Glass>

In the crystallized glass (hereinafter, also referred to as “present crystallized glass”) obtained by the production method according to the present embodiment, the [crystallization starting temperature (Tx)−the glass transition temperature (Tg)] is preferably 200° C. or less, more preferably 150° C. or less, still more preferably 120° C. or lower, and most preferably 100° C. or lower in order to facilitate the formation of at least one of the crystal nucleus and the separated phase in the raw glass sheet. Further, in order to improve the transparency of the obtained crystallized glass, the [crystallization starting temperature (Tx)−glass transition temperature (Tg)] is preferably 50° C. or more, more preferably 70° C. or more, still more preferably 80° C. or more, and most preferably 90° C. or more.

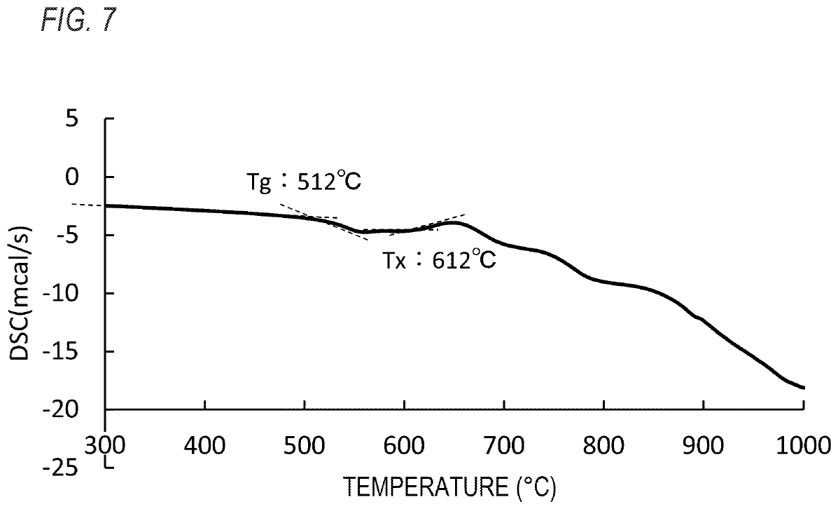

Tx and Tg are determined from a DSC curve obtained with using a differential scanning calorimeter by pulverizing the glass. FIG. 7 is an example of a DSC curve of the raw glass sheet (glass before causing the crystal growth) obtained by one embodiment according to the present invention. In the present specification, as shown in FIG. 7, in the DSC curve before causing the crystal growth, a temperature at which the curve rises during the crystallization is defined as the crystallization starting temperature (Tx).

A crystal included in the present crystallized glass is not particularly limited, and examples thereof include a lithium phosphate-based crystal. Examples of the lithium phosphate-based crystal include the Li₃PO₄ crystal and a Li₄SiO₄ crystal. The present crystallized glass may include, for example, both the Li₃PO₄ crystal and the Li₄SiO₄ crystal, or may include either one as a main crystal. Further, in the present crystallized glass, for example, solid solution crystals of Li₃PO₄ and Li₄SiO₄ may be used as main crystals, or a solid solution crystal of either Li₃PO₄ or Li₄SiO₄ may be used as the main crystal.

The present crystallized glass may be cut to an appropriate length as necessary. A known cutting method can be used, and examples thereof include a cutting method using a diamond cutter and a cutting method using a water jet.

The present crystallized glass may be ground and polished as necessary to form a glass substrate. In a case where the glass substrate is cut into a predetermined shape and size or the glass substrate is chamfered, it is preferable to perform cutting or chamfering of the glass substrate before a chemical strengthening treatment to be described later is performed because a compressive stress layer is also formed on an end surface by the subsequent chemical strengthening treatment.

A shape of the present crystallized glass may be a shape other than a sheet shape depending on a product, a use, or the like to which the present crystallized glass is applied. Further, the glass sheet may have an edged shape in which thicknesses of an outer periphery are different. Furthermore, a form of the glass sheet is not limited thereto. For example, two main surfaces may not be parallel to each other, and all or a part of one or both of the two main surfaces may be curved surfaces. More specifically, the glass sheet may be, for example, a flat sheet-shaped glass sheet having no warpage or a curved glass sheet having a curved surface.

The present crystallized glass may be subjected to a chemical strengthening treatment (ion exchange treatment) to obtain the chemically strengthened glass. The chemical strengthening is performed by the ion exchange treatment. The chemical strengthening treatment can be performed, for example, by immersing the glass sheet in a molten salt such as potassium nitrate heated to 360° C. to 600° C. for 0.1 hours to 500 hours. A heating temperature of the molten salt is preferably 375° C. to 500° C., and an immersion time of the glass sheet in the molten salt is preferably 0.3 hours to 200 hours.

Examples of the molten salt for performing the chemical strengthening treatment include a nitrate, a sulfate, a carbonate, a chloride, and the like. Examples of the nitrate include lithium nitrate, sodium nitrate, potassium nitrate, cesium nitrate, silver nitrate, and the like. Examples of the sulfate include lithium sulfate, sodium sulfate, potassium sulfate, cesium sulfate, silver sulfate, and the like. Examples of the carbonate include lithium carbonate, sodium carbonate, potassium carbonate, and the like. Examples of the chloride include lithium chloride, sodium chloride, potassium chloride, cesium chloride, silver chloride, and the like. These molten salts may be used alone or in combination.

The treatment conditions of the chemical strengthening treatment is not particularly limited, and appropriate conditions may be selected in consideration of the composition (characteristic) of the glass, a type of the molten salt, and a desired chemical strengthening characteristic. The chemical strengthening treatment may be performed only once, or may be performed a plurality of times (multistage strengthening) under two or more different conditions.

Examples of applications of the present crystallized glass include cover glass used for an electronic device such as a mobile device, for example, a mobile phone and a smartphone. Further, the examples thereof include cover glass for an electronic device such as a television, a personal computer, a touch panel, and the like, an elevator wall surface, or a wall surface (full-screen display) of a construction such as a house and a building, which is not intended to be carried. Further, the examples thereof include a building material such as window glass, a table top, an interior of an automobile, an airplane, or the like, and a cover glass thereof, or a casing having a curved surface shape.

As described above, the following matters are disclosed in the present specification.

[1] A production method of a crystallized glass, the method including the following (a1) to (a4):
(a1) obtaining a molten glass by melting a glass raw material;
(a2) obtaining a glass molded body by molding the molten glass into a predetermined shape with a molding unit;
(a3) obtaining a raw glass sheet including at least one of a crystal nucleus and a separated phase by annealing the glass molded body; and
(a4) obtaining the crystallized glass by causing crystal growth through heat treatment of the raw glass sheet including at least one of the crystal nucleus and the separated phase.

2. The production method according to [1], in which
the (a2) and the (a3) are simultaneously performed, and the raw glass sheet including at least one of the crystal nucleus and the separated phase is obtained by annealing while molding the molten glass into the predetermined shape with the molding unit.

[3] The production method according to [1] or [2], in which
the raw glass sheet including at least one of the crystal nucleus and the separated phase has a peak in small angle X-ray scattering analysis.

[4] The production method according to any one of [1] to [3], in which
the raw glass sheet including at least one of the crystal nucleus and the separated phase has an inter-particle distance of 10 nm to 100 nm as measured by small angle X-ray scattering.

[5] The production method according to any one of [2] to [4], further including:
obtaining the molten glass by melting the glass raw material at a temperature T1 in the (a1);
obtaining the raw glass sheet including at least one of the crystal nucleus and the separated phase at a temperature T2 in the (a2) and the (a3); and
obtaining the crystallized glass by causing crystal growth through heat treatment of the raw glass sheet at a temperature T3 in the (a4), in which
the temperature T2 is lower than the temperatures T1 and T3.

[6] A production method of a crystallized glass, the method including the following (b1) to (b3):
(b1) obtaining a molten glass by melting a glass raw material;
(b2) obtaining a raw glass sheet including at least one of a crystal nucleus and a separated phase by annealing while molding the molten glass into a predetermined shape with a molding unit; and
(b3) obtaining the crystallized glass by causing crystal growth through heat treatment of the raw glass sheet including at least one of the crystal nucleus and the separated phase.

[7] A production method of a crystallized glass, the method including the following (c1) to (c3):
(c1) obtaining a molten glass by melting a glass raw material;
(c2) obtaining a raw glass sheet having a peak in small angle X-ray scattering analysis by annealing while molding the molten glass into a predetermined shape with a molding unit; and
(c3) obtaining the crystallized glass by causing crystal growth through heat treatment of the raw glass sheet having the peak in the small angle X-ray scattering analysis.

[8] A production method of a crystallized glass, the method including the following (d1) to (d3):
(d1) obtaining a molten glass by melting a glass raw material;
(d2) obtaining a raw glass sheet having an inter-particle distance of 10 nm to 100 nm as measured by small angle X-ray scattering by annealing while molding the molten glass into a predetermined shape with a molding unit; and
(d3) obtaining the crystallized glass by causing crystal growth through heat treatment of the raw glass sheet having the inter-particle distance of 10 nm to 100 nm as measured by the small angle X-ray scattering.

[9] A production method of a crystallized glass through temperature processes of temperatures T1, T2, and T3, in which
the temperature T2 is lower than the temperatures T1 and T3, and
the method includes obtaining a raw glass sheet including at least one of a crystal nucleus and a separated phase at the temperature of T2.

[10] The production method according to any one of [1] to [9], in which
the crystallized glass includes, in terms of mol % based on oxides,
40% to 70% of SiO₂,
10% to 35% of Li₂O,
1% to 15% of Al₂O₃,
0.5% to 5% of P₂O₅,
0.5% to 5% of ZrO₂,
0% to 10% of B₂O₃,
0% to 3% of Na₂O,
0% to 1% of K₂O, and
0% to 4% of SnO₂, and
the crystallized glass has a total amount of SiO₂, Al₂O₃, P₂O₃, and B₂O₃ of 60% to 80%.

[11] The production method according to [10], in which
the crystallized glass further includes 5% or more of Al₂O₃ and 2% or more of ZrO₂ in terms of mol % based on oxides.

[12] The production method according to any one of [1] to [9], in which
the crystallized glass includes, in terms of mol % based on oxides,
50% to 70% of SiO₂,
15% to 30% of Li₂O,
1% to 10% of Al₂O₃,
0.5% to 5% of P₂O₅,
0.5% to 8% of ZrO₂.
0.1% to 10% of MgO,
0% to 5% of Y₂O₃,
0% to 10% of B₂O₃,
0% to 3% of Na₂O,
0% to 1% of K₂O, and
0% to 2% of SnO₂.

[13] The production method according to any one of [1] to [12], in which the crystallized glass has a [crystallization starting temperature (Tx)−glass transition temperature (Tg)] of 50° C. to 200° C.

### EXAMPLES

Hereinafter, the present invention will be described with reference to Examples, but the present invention is not limited thereto.

### Example 1

Crystallized glass was produced by the following melting step, molding step, annealing step and crystal growth step and evaluated. Example 1 is a working example.

[Melting Step]

Raw materials of components of the crystallized glass were weighed out such that SiO₂ was 61 mol %, Al₂O₃ was 5 mol %, Li₂O was 21 mol %, Na₂O was 2 mol %, P₂O₅ was 2 mol %, MgO was 5 mol %, ZrO₂ was 3 mol %, Y₂O₃ was 1 mol %, and SO₃ was 0.3 mass % based on oxides, and uniformly mixed. The mixed raw materials were put into a platinum crucible, put into an electric furnace at 1600° C. and melted for about 5 hours to thereby obtain a molten glass.

[Molding Step and Annealing Step]

After the molten glass obtained in the melting step was defoamed and homogenized, the molten glass was poured into a mold, held at a temperature of 540° C. for 30 minutes, and then cooled to room temperature at a rate of 0.5° C./min to thereby obtain a raw glass sheet (glass block) having a thickness of 20 mm. The obtained raw glass sheet was analyzed by the small angle X-ray scattering. Further, a DSC curve of the obtained raw glass sheet was measured using the differential scanning calorimeter (DSC3300SA manufactured by Bruker).

(Small Angle X-Ray Scattering)

The raw glass sheet was analyzed by the small angle X-ray scattering (SAXS) under the following conditions.
Device: synchrotron radiation, beamline “BL8S3”, small angle X-ray scattering
Device location: 250-3 Minamiyamaguchi-cho, Seto-shi, Aichi-ken, “Knowledge Hub Aichi”, public interest incorporated foundation
Science & Technology Foundation Aichi Synchrotron Radiation Center
Energy (wavelength), 0.92 Å
Measurement detector: PILATUS
Measurement time: 480 sec
Measurement camera length: 2180.9 mm

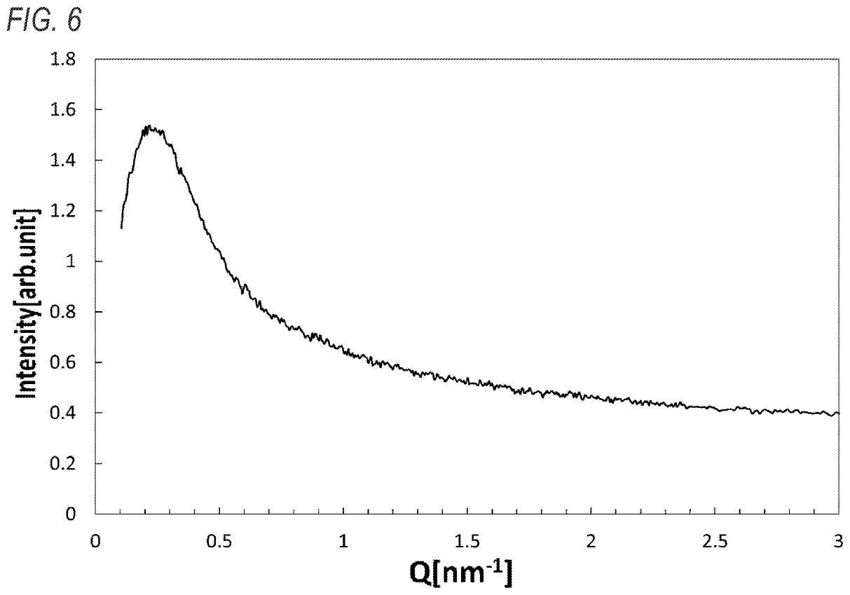

Results obtained by the measurement are shown in FIG. 6. From the results shown in FIG. 6, an inter-particle distance L was obtained by the following formula.

L=2π/Qmax

Qmax is a value of Q (nm⁻¹) (scattering vector) corresponding to a peak of a maximum value of intensity of SAXS data, which clearly has a peak as shown in FIG. 6. A clear peak means that [highest intensity]/[intensity when Q(nm⁻¹) is 3] is greater than 1.

As shown in FIG. 6, the raw glass sheet has a peak in the small angle X-ray scattering, and it is found that at least one of the crystal nucleus and the separated phase is formed. Further, Qmax is 0.22 nm⁻¹, and an average inter-particle distance is 29 nm.

(DSC)

The obtained raw glass sheet was pulverized by using an agate mortar such that a particle size is 106 μm to 180 μm so as to obtain powder. Among the obtained powder, about 80 mg of the powder was put into a platinum cell and heated from room temperature to 1100° C. at a heating rate of 10° C./min, and a DSC curve was measured by using the differential scanning calorimeter (DSC3300SA manufactured by Bruker). The results are shown in FIG. 7.

As shown in FIG. 7, it is found that Tg is 512° C., and Tx is 612° C.

[Crystal Growth Step]

The raw glass sheet obtained in the annealing step was placed in a heat treatment furnace. In the heat treatment furnace, the raw glass sheet was heated to about 750° C. (at a heating rate of 5° C./min) and held for about 2 hours. Thereafter, the raw glass sheet was cooled to room temperature (at a cooling rate of 5° C./min) to thereby obtain the crystallized glass.

Crystallized glass in Example 2 was obtained in the same manner as in Example 1 except that the thickness of the raw glass sheet was changed to 50 mm in the molding step in Example 1. For the crystallized glass in Examples 1 and 2, haze at a central portion in a thickness direction was measured. As a result, the haze was better in Example 1 in which the thickness of the raw glass sheet was 20 mm than in Example 2 in which the thickness was 50 mm.

Although the present invention has been described in detail with reference to specific embodiments, it is apparent to those skilled in the art that various changes and modifications can be made without departing from the spirit and scope of the present invention. The present application is based on Japanese patent application No. 2021-091740 filed on May 31, 2021, and the contents thereof are incorporated herein by reference.

1. A production method of a crystallized glass, the method comprising the following (a1) to (a4):
(a1) obtaining a molten glass by melting a glass raw material;
(a2) obtaining a glass molded body by molding the molten glass into a predetermined shape with a molding unit;
(a3) obtaining a raw glass sheet including at least one of a crystal nucleus and a separated phase by annealing the glass molded body; and
(a4) obtaining the crystallized glass by causing crystal growth through heat treatment of the raw glass sheet including at least one of the crystal nucleus and the separated phase.

2. The production method according to claim 1, wherein
the (a2) and the (a3) are simultaneously performed, and the raw glass sheet comprising at least one of the crystal nucleus and the separated phase is obtained by annealing while molding the molten glass into the predetermined shape with the molding unit.

3. The production method according to claim 1, wherein
the raw glass sheet comprising at least one of the crystal nucleus and the separated phase has a peak in small angle X-ray scattering analysis.

4. The production method according to claim 1, wherein
the raw glass sheet comprising at least one of the crystal nucleus and the separated phase has an inter-particle distance of 10 nm to 100 nm as measured by small angle X-ray scattering.

5. The production method according to claim 2, further comprising:
obtaining the molten glass by melting the glass raw material at a temperature T1 in the (a1);
obtaining the raw glass sheet comprising at least one of the crystal nucleus and the separated phase at a temperature T2 in the (a2) and the (a3); and
obtaining the crystallized glass by causing crystal growth through heat treatment of the raw glass sheet at a temperature T3 in the (a4) wherein
the temperature T2 is lower than the temperatures T1 and T3.

6. A production method of a crystallized glass, the method comprising the following (d1) to (d3):
(d1) obtaining a molten glass by melting a glass raw material;
(d2) obtaining a raw glass sheet having an inter-particle distance of 10 nm to 100 nm as measured by small angle X-ray scattering by annealing while molding the molten glass into a predetermined shape with a molding unit; and
(d3) obtaining the crystallized glass by causing crystal growth through heat treatment of the raw glass sheet having the inter-particle distance of 10 nm to 100 nm as measured by the small angle X-ray scattering.

7. A production method of a crystallized glass through temperature processes of temperatures T1, T2, and T3, wherein
the temperature T2 is lower than the temperatures T1 and T3, and
the method comprises obtaining a raw glass sheet comprising at least one of a crystal nucleus and a separated phase at the temperature of T2.

8. The production method according to claim 1, wherein
the crystallized glass comprises, in terms of mol % based on oxides,
40% to 70% of SiO₂,
10% to 35% of Li₂O,
1% to 15% of Al₂O₃,
0.5% to 5% of P₂O₅,
0.5% to 5% of ZrO₂,
0% to 10% of B₂O₃,
0% to 3% of Na₂O,
0% to 1% of K₂O, and
0% to 4% of SnO₂, and
the crystallized glass has a total amount of SiO₂, Al₂O₃, P₂O₅, and B₂O₃ of 60% to 80%.

9. The production method according to claim 8, wherein
the crystallized glass further comprises 5% or more of Al₂O₃ and 2% or more of ZrO₂ in terms of mol % based on oxides.

10. The production method according to claim 1, wherein
the crystallized glass comprises, in terms of mol % based on oxides,
50% to 70% of SiO₂,
15% to 30% of Li₂O,
1% to 10% of Al₂O₃,
0.5% to 5% of P₂O₅,
0.5% to 8% of ZrO₂,
0.1% to 10% of MgO,
0% to 5% of Y₂O₃,
0% to 10% of B₂O₃,
0% to 3% of Na₂O,
0% to 1% of K₂O, and
0% to 2% of SnO₂.

11. The production method according to claim 1, wherein
the crystallized glass has a [crystallization starting temperature (Tx)−glass transition temperature (Tg)] of 50° C. to 200° C.

12. The production method according to claim 6, wherein
the crystallized glass comprises, in terms of mol % based on oxides,
40% to 70% of SiO₂,
10% to 35% of Li₂O,
1% to 15% of Al₂O₃,
0.5% to 5% of P₂O₅,
0.5% to 5% of ZrO₂,
0% to 10% of B₂O₃,
0% to 3% of Na₂O,
0% to 1% of K₂O, and
0% to 4% of SnO₂, and
the crystallized glass has a total amount of SiO₂, Al₂O₃, P₂O₅, and B₂O₃ of 60% to 80%.

13. The production method according to claim 7, wherein
the crystallized glass comprises, in terms of mol % based on oxides,
40% to 70% of SiO₂,
10% to 35% of Li₂O,
1% to 15% of Al₂O₃,
0.5% to 5% of P₂O₅,
0.5% to 5% of ZrO₂,
0% to 10% of B₂O₃,
0% to 3% of Na₂O,
0% to 1% of K₂O, and
0% to 4% of SnO₂, and
the crystallized glass has a total amount of SiO₂, Al₂O₃, P₂O₅, and B₂O₃ of 60% to 80%.

14. The production method according to claim 12, wherein
the crystallized glass further comprises 5% or more of Al₂O₃ and 2% or more of ZrO₂ in terms of mol % based on oxides.

15. The production method according to claim 13, wherein
the crystallized glass further comprises 5% or more of Al₂O₃ and 2% or more of ZrO₂ in terms of mol % based on oxides.

16. The production method according to claim 6, wherein
the crystallized glass comprises, in terms of mol % based on oxides,
50% to 70% of SiO₂,
15% to 30% of Li₂O,
1% to 10% of Al₂O₃,
0.5% to 5% of P₂O₅,
0.5% to 8% of ZrO₂,
0.1% to 10% of MgO,
0% to 5% of Y₂O₃,
0% to 10% of B₂O₃,
0% to 3% of Na₂O,
0% to 1% of K₂O, and
0% to 2% of SnO₂.

17. The production method according to claim 7, wherein
the crystallized glass comprises, in terms of mol % based on oxides,
50% to 70% of SiO₂,
15% to 30% of Li₂O,
1% to 10% of Al₂O₃,
0.5% to 5% of P₂O₅,
0.5% to 8% of ZrO₂,
0.1% to 10% of MgO,
0% to 5% of Y₂O₃,
0% to 10% of B₂O₃,
0% to 3% of Na₂O,
0% to 1% of K₂O, and
0% to 2% of SnO₂.

18. The production method according to claim 6, wherein
the crystallized glass has a [crystallization starting temperature (Tx)−glass transition temperature (Tg)] of 50° C. to 200° C.

19. The production method according to claim 7, wherein
the crystallized glass has a [crystallization starting temperature (Tx)−glass transition temperature (Tg)] of 50° C. to 200° C.
